(19) United States
(12) Patent Application Publication
(10) Pub. No.: US 2018/0201529 A1
(43) Pub. Date: Jul. 19, 2018

(54) Apparatus and Methods to Recover Media from an Activated Iron Process

(71) Applicant: FVOQUA WATER TECHNOLOGIES LLC, Warrendale, PA (US)

(72) Inventors: Simon Paul Dukes, Chelmsford, MA (US); Michael W. Wismer, Lino Lakes, MN (US); Frank L. Sassaman, Fombell, PA (US); Joseph D. Gifford, Marlborough, MA (US); Adam Szczesniak, Berlin, CT (US)

(21) Appl. No.: 15/035,419

(22) PCT Filed: Oct. 31, 2014
(86) PCT No.: PCT/US2014/063335

§ 371 Date: May 9, 2016

Related U.S. Application Data
(60) Provisional application No. 61/899,505, filed on Nov. 4, 2013.
(60) Provisional application No. 61/900,544, filed on Nov. 6, 2013.

(51) Int. Cl. C02F 1/70; C02F 1/00; C02F 1/48; C02F 1/66; C02F 1/74

(52) U.S. Cl. CPC C02F 1/705; C02F 1/004; C02F 1/488; C02F 2101/20; C02F 1/74; C02F 2301/046; C02F 1/66

(57) ABSTRACT

Systems and methods for treating wastewater are disclosed. Zero valent iron media may be used in a moving packed bed reactor. A media recovery system may return media to the reactor.

### CROSS-REFERENCE TO RELATED APPLICATIONS

This application claims priority under 35 U.S.C. § 119(e) to U.S. Provisional Patent Application Ser. No. 61/899,505, titled “APPARATUS AND METHOD FOR A MOVING BED ACTIVATED IRON PROCESS,” filed on Nov. 4, 2013, and to U.S. Provisional Patent Application Ser. No. 61/900,544, titled “APPARATUS AND METHODS TO RECOVER MEDIA FROM AN AERATED ACTIVATED IRON PROCESS,” filed on Nov. 6, 2013, each of which being herein incorporated by reference in its entirety for all purposes.

### BACKGROUND

### 1. Field of Disclosure

Aspects and embodiments of the present disclosure are directed generally to wastewater treatment systems utilizing moving media beds and methods of operating the same.

### 2. Discussion of Related Art

Various methods for the treatment of wastewater involve contacting the wastewater to be treated with a catalyzing media. The media facilitates the removal of undesirable components from the wastewater by adsorption and/or by chemical transformation of undesirable soluble components into compounds which are less soluble and thus easier to remove from the wastewater. Media assisted wastewater treatment processes may be performed in reactors having a packed bed and/or a fluidized bed arrangement.

### SUMMARY

In accordance with an aspect of the present disclosure, there is provided a wastewater treatment system. The wastewater treatment system comprises a wastewater inlet and a vessel including a moving packed media bed. The vessel is configured to receive wastewater to be treated from the wastewater inlet and to contact the wastewater to be treated with a catalyzing media in the moving packed media bed to produce treated water. The wastewater treatment system further comprises an effluent outlet in fluid communication with the vessel and configured to receive the treated water from the vessel, and a media recirculation system configured to transport catalyzing media from a first portion of the moving packed media bed to a second portion of the moving packed media bed.

In some embodiments, the media recirculation system includes a riser tube and a motive force generator configured to move catalyzing media up through the riser tube. On some embodiments, the motive force generator may be configured to move catalyzing media down through the riser tube. The motive force generator may include an auger. The motive force generator may include a gas inlet disposed beneath the riser tube.

In some embodiments, the media recirculation system includes an eductor in fluid communication with a source of motive water.

In some embodiments, the media recirculation system includes a conduit passing through the moving packed media bed, the conduit including an aperture in communication with the catalyzing media and an upper end positioned over the top of the moving packed media bed and a fluid pulse generator configured to apply a fluid pulse to the conduit and eject catalyzing media from within the conduit into a media plume above the top of the moving packed media bed.

In some embodiments, the wastewater treatment system further comprises a media recovery system in fluid communication with the effluent outlet and configured to remove catalyzing media from the effluent and return the catalyzing media to the vessel.

In accordance with another aspect of the present disclosure, there is provided a wastewater treatment system. The wastewater treatment system comprises a wastewater inlet and a vessel including a moving packed media bed. The vessel is configured to receive wastewater to be treated from the wastewater inlet and to contact the wastewater to be treated with a catalyzing media in the moving packed media bed to produce treated water. The wastewater treatment system further comprises an effluent outlet in fluid communication with the vessel and configured to receive the treated wastewater from the vessel, a media recirculation system configured to transport catalyzing media from a first portion of the moving packed media bed to a second portion of the moving packed media bed, and a media recovery system in fluid communication with the effluent outlet and configured to remove catalyzing media from the effluent and return the removed catalyzing media to the vessel.

In accordance with another aspect of the present disclosure, there is provided a method of treating wastewater. The method comprises introducing the wastewater into a reactor including a catalyzing media, contacting the wastewater with the catalyzing media in the reactor to form an effluent, moving a portion of the catalyzing media from a first position in the reactor to a second position in the reactor, removing the effluent from the reactor, removing catalyzing media from the effluent removed from the reactor, and recycling the removed catalyzing media to the reactor.

In some embodiments, moving the portion of the catalyzing media comprises forming a moving packed bed from the catalyzing media in the reactor.

In some embodiments, moving the portion of the catalyzing media from the first position in the reactor to the second position in the reactor includes moving the portion of the catalyzing media from a lower portion of the moving packed bed to an upper portion of the moving packed bed.

In accordance with another aspect of the present disclosure, there is provided a wastewater treatment system. The wastewater treatment system comprises a wastewater inlet in fluid communication with a source of wastewater including a soluble contaminant, a vessel configured to receive wastewater to be treated from the wastewater inlet and contact the wastewater to be treated with a catalyzing media in the vessel. The soluble contaminant may be a soluble heavy metal contaminant. The soluble contaminant may include one of selenium, mercury, and thallium. The catalyzing media is configured to one of precipitate and adsorb at least a portion of the soluble contaminant and produce treated water. The wastewater treatment system further comprises an effluent outlet in fluid communication with the vessel and configured to receive the treated water from the vessel, and a media recovery system in fluid communication with the effluent outlet and configured to selectively remove active catalyzing media as compared to spent catalyzing media from the treated water and return the active catalyzing media to the vessel.

In some embodiments, the media recovery system includes a gravity-based separator.

In some embodiments, the media recovery system includes a magnetic separator.

In some embodiments, the vessel includes a fluidized bed reactor.

In some embodiments, the vessel includes a packed bed reactor including a moving packed bed of the catalyzing media and a subsystem configured to generate the moving packed bed of the catalyzing media by moving catalyzing media from a bottom of the packed bed to a top of the packed bed.

In some embodiments, the subsystem includes a riser tube and a motive force generator configured to move catalyzing media up through the riser tube. The motive force generator may include an auger. The motive force generator may include a gas inlet disposed beneath the riser tube.

In some embodiments, the subsystem includes an eductor in fluid communication with a source of motive water.

In some embodiments, the subsystem includes a sand filter.

In some embodiments, the subsystem includes a conduit passing through the packed bed, the conduit including an aperture in communication with the catalyzing media and an upper end positioned over the top of the packed bed, and a fluid pulse generator configured to apply a fluid pulse to the conduit and eject catalyzing media from within the conduit into a media plume above the top of the packed bed.

In some embodiments, the vessel includes a plurality of stacked packed media beds.

In accordance with another aspect of the present disclosure, there is provided a method of treating wastewater including a heavy metal contaminant. The method comprise introducing the wastewater into a vessel including a catalyzing media, the catalyzing media configured to one of precipitate and adsorb at least a portion of the soluble heavy metal contaminant and produce treated water, removing the treated water from an effluent outlet in fluid communication with the vessel, selectively removing active catalyzing media as compared to spent catalyzing media from the treated water, and returning the active catalyzing media to the vessel.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a diagram of an embodiment of a fluidized bed reactor system;

FIG. 2 is a diagram of an embodiment of a magnetic media separation system;

FIG. 3 is a diagram of an embodiment of a hydrocyclone;

FIG. 4 is a schematic diagram of an embodiment of a packed bed reactor;

FIG. 5A is a diagram of an embodiment of an Archimedean screw pump;

FIG. 5B is a diagram of another embodiment of an Archimedean screw pump;

FIG. 6 is a diagram of an embodiment of a moving packed bed reactor;

FIG. 7 is a diagram of another embodiment of a moving packed bed reactor;

FIG. 8 is a diagram of further embodiment of a moving packed bed reactor;

FIG. 9A is a diagram of an embodiment of a media dispersant system for a packed bed reactor in a first state;

FIG. 9B is a diagram of the media dispersant system of FIG. 9A in a second state;

FIG. 10 is a diagram of an embodiment of a stacked moving packed bed reactor;

FIG. 11 is a diagram of another embodiment of a stacked moving packed bed reactor; and

FIG. 12 is a diagram of further embodiment of a stacked moving packed bed reactor.

### DETAILED DESCRIPTION

Aspects and embodiments disclosed herein are not limited to the details of construction and the arrangement of components set forth in the following description or illustrated in the drawings. Aspects and embodiments disclosed herein are capable of other embodiments and of being practiced or of being carried out in various ways.

In accordance with one or more embodiments, water may be treated with activated iron. An activated iron water treatment process may utilize a media, for example, zero valent iron in combination with a source or ferrous ions, for example, ferrous chloride to reduce a concentration of heavy metals and/or oxyanions in influent water to be treated. It has been found that the efficiency of a water treatment process using zero valent iron increases as the size of the particles of the zero valent iron decreases, however, as the size of the particles decrease, the media becomes more subject to packing into dense agglomerates or to fusing, thus increasing resistance of flow of water to be treated through the media and/or making less media surface area available for contact with the water. In a packed bed reactor, the media is compressed within a reactor that provides contact between the media with the liquid to be treated. Either a packed column or a radial flow device can be used in a packed bed arrangement to treat and remove contaminants, for example, selenium, mercury, and thallium. When activated iron media is used in a packed bed configuration, however, the media can fuse together. Fusing of the media may cause a blockage of liquid flow and reduce the efficiency of the treatment process.

As the media size decreases, it becomes less practical to use the media in a traditional packed bed arrangement. An activated iron water treatment process may be more effectively performed in, for example, a moving packed bed reactor or a fluidized media bed reactor than in a packed bed reactor in accordance with various embodiments. As the term is used herein, a “moving packed bed reactor” is a reactor having a packed bed, for example, a constrained or unconstrained pile, of catalyzing media wherein the catalyzing media in the bed is moved over time from one portion of the bed to another portion of the bed, for example, from a bottom portion of the media bed to a top portion of the media bed or from a top portion of the media bed to a bottom portion of the media bed. The movement of the media helps to keep the media from fusing, which as discussed above may be problematic in previously known systems utilizing media such as ZVI with small particle sizes. A moving packed bed reactor may also be referred to as any one or more of a “progressive bed” reactor, a “dynamic bed” or “dynamic column” reactor, a “rolling bed” reactor, a “rapid bed” reactor, a “travelling bed” reactor, a “countercurrent bed” reactor, a “fluidic bed” reactor, an “active bed” reactor, or a “migrating bed” reactor.

During operation of a fluidized bed reactor or a moving packed bed reactor, some of the activated iron media can be lost due to the turbulence of liquid in the reactor, for example, turbulence due to stirring of a fluidized bed reactor or from movement of the media bed in a moving packed bed reactor. Some aspects and embodiments disclosed herein facilitate recovery of media, for example, activated iron media that might otherwise be lost, and return of the recovered media to a reactor from which the media might otherwise have escaped. During the media recovery process, media which is still in an “active” state may be preferentially recovered as compared to media which has become spent or non-active.

In use, a fluidized bed reactor may be continuously or periodically stirred to increase contact between the media and the influent water undergoing treatment. In a fluidized bed reactor, turbulence within the reactor may cause the media to be constantly suspended. This can improve the reaction kinetics by increasing velocity and contaminant interaction within the reactor so that it is possible to rapidly treat and remove contaminants, for example, selenium, mercury, and thallium. Stirring of the fluidized bed may also help prevent the media from fusing together.

In some embodiments, media comprising zero-valent iron (hereinafter Fe(0) or “ZVI”) may be provided as small particles or as a powder. In some embodiments, the ZVI powder may have an average particle size of less than about 100 μm, for example, less than about 90 μm or less than about 45 μm. The ZVI media particles may, in some embodiments, be coated to enhance the contaminant removal efficiency of the media. As used herein, the term “coated” may include “having an outer layer at least partially covered with,” or “having an outer layer chemically or electrochemically converted to include.” In some embodiments, it has been found beneficial to coat the ZVI particles with an iron-containing material, for example, an iron oxide. The ZVI media particles may, in some embodiments, be coated with a layer of magnetite.

In some embodiments a layer of magnetite (Fe₃O₄) is coated on to the ZVI particles by chemically or electrochemically converting the outer layer of the ZVI particles as a conditioning step to maintain the activity of the ZVI during the process of treating wastewater. The removal of contaminants, for example, selenium from wastewater may include the reduction of the high oxidation state of the selenium (+6, +4, etc.) to insoluble elemental selenium by the ZVI. The elemental selenium (or other contaminant) may then be adsorbed to the catalytic media such as ZVI media. The reduction of selenium and other contaminant elements may involve electron transfer from the ZVI to the target element. Without being bound to a particular theory, an example of a reduction reaction of, for example, selenium may occur according to the following reaction:

Se0₄²⁻+2Fe(0)+Fe²⁺4Se(0)+Fe₃0₄

Aspects and embodiments disclosed herein may also be useful in removing other components, for example, one or more of silica, aluminum, arsenic, cadmium, chromium, copper, lead, mercury, molybdenum, nickel, thallium, and zinc from wastewater.

Over time, the conversion of the ZVI to iron oxides and/or the accumulation of contaminants adsorbed on the surface of the media particles may render the media less effective at removing contaminants from wastewater than fresh media. Media which has become less effective or ineffective for removing contaminants from wastewater may be referred to herein as “spent” or “inactive” media. In some embodiments, the concentration of one or more contaminants in treated water exiting a fluidized bed reactor may be monitored and when this concentration exceeds a desired level, the media in the fluidized bed reactor may be replaced with fresh media. Additionally or alternatively, a fluidized bed reactor may be operated in a “feed and bleed” mode where spent media is removed from the fluidized bed reactor as fresh media is added, allowing the fluidized bed reactor to operate for extended periods of time without being taken out of operation to replace the media. Similar methods of monitoring for breakthrough of contaminants in treated water and of replacement of media, ether as a complete replacement of media or a “feed and bleed” mode of media replenishment may also be applied to moving packed bed reactors as disclosed herein.

The magnetite layer is coated on the ZVI particles to facilitate the electron transfer from the ZVI to the target contaminant element(s). Magnetite, with a small band gap between the valence and the conductance band, is a good electron carrier and therefore facilitates the reduction of the target element by electron transfer from ZVI to the contaminant(s). The magnetite layer coated on the ZVI may also passivate the ZVI and facilitate prevention of oxidation of the ZVI. The magnetite coating may in some embodiments be very thin, for example, in a range of from about a monolayer to about a micron in thickness.

In some embodiments where ZVI is used as a contaminant removal media, wastewater to be treated may be dosed with chemicals to increase a concentration of Fe²⁺ ions in the wastewater prior to, or during contact of the wastewater with the ZVI media. The Fe²⁺ ions may facilitate maintaining the ZVI media in an active magnetite state and prevent substantial oxidation of the ZVI media to inactive oxides. Without being bound to any particular theory, an example of a reaction between the Fe²⁺ and the ZVI may include the following reaction:

2γ-FeOOH+Fe²⁺→Fe₃0₄+2H⁺

The Fe²⁺ ions may be introduced in the form of FeCl₂ or FeSO₄ stock solutions at a set flow rate to maintain the concentration of Fe²⁺ ions in the wastewater coming into contact with the ZVI media in a range of, for example, between about 5 mg/L to about 200 mg/L. In some non-limiting embodiments, the range may be between about 5 mg/L to about 50 mg/L. In some embodiments where the wastewater is contaminated with Ni which is to be removed, lower Fe²⁺ dosages may be utilized, for example, dosages sufficient to maintain the concentration of Fe²⁺ ions in the wastewater coming into contact with the ZVI media in a range of, for example, between about 0 mg/L to about 5 mg/L. The desired concentration of Fe²⁺ may be dependent upon the concentration and type of contaminants in the wastewater which are desired to be removed. If more than a desired amount of Fe²⁺, for example, more than is needed to reduce a desired amount of the contaminant ions and maintain the ZVI in an active state, is added to the wastewater to be treated excess Fe²⁺ in the wastewater, from dosage as well from in situ generation, will exit the media bed. In some embodiments the effluent of a fluidized bed reactor including the ZVI media may be monitored for the soluble iron levels and the dosage of Fe²⁺ may be adjusted until the concentration of soluble iron in the effluent drops below a desired threshold level.

In one embodiment, the process is operated as a fluidized bed reactor using mixers and riser tubes with continuous or intermittent addition of ferrous ion. During operation some of the media may exit with the overflow (also referred to herein as “effluent”) and may be removed by downstream aeration or filtration. In embodiments in which the active media is magnetic, a magnetic separation such as a magnetic-drum may be used to recover the active media and return it to the reactor.

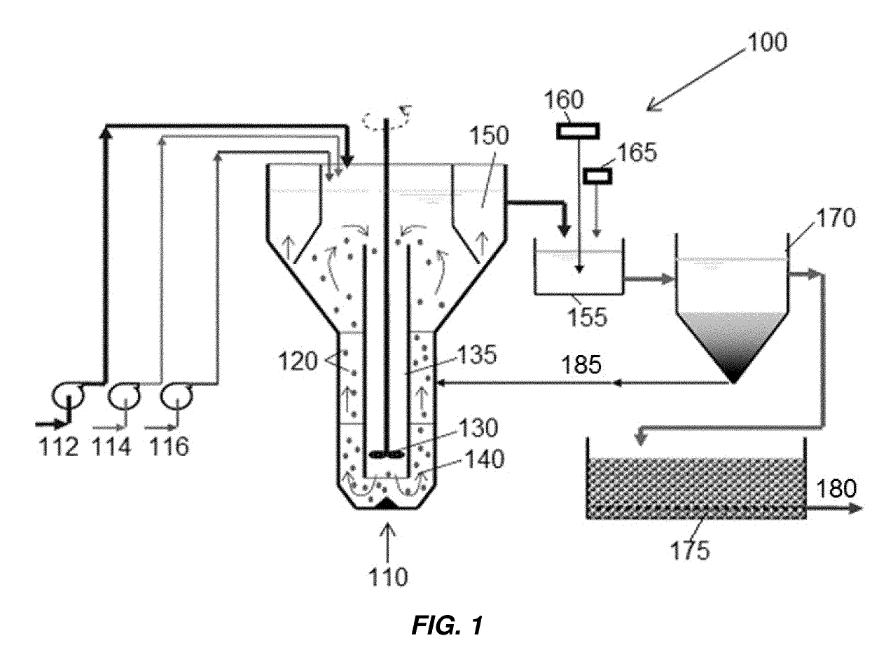

FIG. 1 illustrates a diagram of a fluidized bed reactor system 100. The system 100 includes a fluidized bed reactor 110. In some embodiments, the fluidized bed reactor may include between about 50 g/L and about 400 g/L of media, for example, ZVI media. In at least some embodiments, the reactor may include between about 100 g/L and about 200 g/L of media. Wastewater is supplied to the fluidized bed reactor 110 through a first pump 112. Other reagents, for example, Fe²⁺ and/or HCl may be supplied to the fluidized bed reactor through second and third pumps 114, 116, respectively. As described above, the Fe²⁺ may facilitate maintaining ZVI media 120 in the fluidized bed reactor 110 in an active magnetite state and prevent substantial oxidation of the ZVI media to inactive oxides. The HCl or other reatent may be used to maintain the pH of fluid in the fluidized bed reactor 110 at a level which facilitates the reduction of selenium compounds such as selenite and selenate into elemental selenium. In some non-limiting embodiments, the pH level in the fluidized bed reactor may be maintained at a level of, for example, between about 2.2 and about 2.4. In at least some embodiments, the pH level of the reactor may be increased or decreased.

A stirrer or mixer 130 in a flow conduit 135 of the fluidized bed reactor 110 may circulate liquid through the fluidized bed reactor 110 to facilitate mixing and contact of contaminants in the wastewater undergoing treatment with the media 120 in the fluidized bed reactor 110. The stirrer 130 also facilities maintaining the media 120 suspended in fluid in the fluidized bed reactor 110, for example, in a fluidized zone 140 of the fluidized bed reactor 110.

An oxygen containing gas, for example, air may be provided from a source of air, for example, a compressor, blower, or other device capable of pressurizing air into the fluidized bed reactor 110 into a portion of the flow conduit 135. Oxygen in the air may facilitate oxidation of selenocyanate in the wastewater undergoing treatment into selenite and/or selenate which is then reduced into elemental selenium when contacted with the ZVI media 120.

Suspended solids in the wastewater undergoing treatment are removed from the fluidized bed reactor 110 in an internal settling zone 150 and then transferred to an aeration basin 155 supplied with air from a source of air 160, where the solids may be aerobically treated in a biological treatment process. In some embodiments, a chemical process may occur in the aeration basin 155 in which soluble iron is converted to an iron oxide or an iron hydroxide which may be settled. Fluid in the aeration basin 155 may be pH adjusted by the addition of a base, for example, NaOH from a source of NaOH 165. Mixed liquor generated in the aeration basin undergoes solids/liquid separation in a settling tank or clarifier 170. A low solids effluent from the settling tank or clarifier 170 is discharged as treated water 180 after optionally passing through a final filter, for example, a sand filtration bed 175. High solids sludge 185 may be returned from the settling tank or clarifier 170 to the fluidized bed reactor 110 for use in capturing additional suspended or dissolved solids from wastewater undergoing treatment in the fluidized bed reactor 110.

In some embodiments, a media recovery mechanism is located between an outlet of the fluidized bed reactor 110 and an inlet of the aeration basin 155. The media recovery mechanism may recover media from the fluid stream flowing from the fluidized bed reactor 110 to the aeration basin 155, so the media may be returned to the fluidized bed reactor 110. In some embodiments, between about 10% and about 90%, for example, between about 20% and about 80% of active media leaving the fluidized bed reactor 110 may be recovered by the media recovery mechanism. The media recovery mechanism may include any mechanism capable of recovering or separating media from the fluid from the fluidized bed reactor.

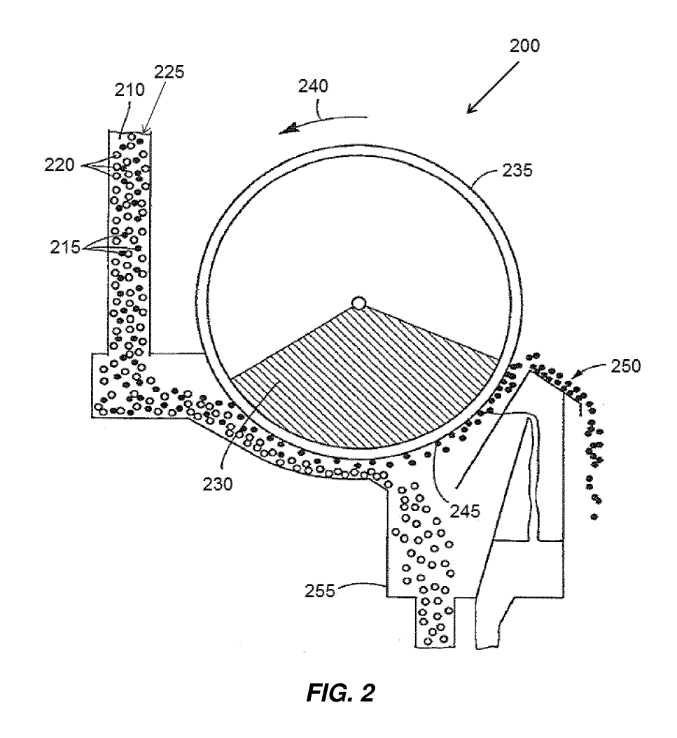

In one embodiment, the media recovery mechanism includes a magnetic separation apparatus, for example, a magnetic drum separator. Referring to FIG. 2, an embodiment of a magnetic drum separation apparatus 200 is illustrated. Influent 210 removed from an outlet of the fluidized bed reactor 110 illustrated in FIG. 1, which may include magnetic particles 215, for example, ZVI and/or magnetite-coated ZVI, and non-magnetic particles 220 are directed to the feed inlet 225 of the magnetic drum separation apparatus 200. Permanent magnets 230 are located on the interior of a drum 235. These permanent magnets 230 are in a fixed location and generate a magnetic field over a fraction of the drum surface, for example, between about ⅓ and ⅔ of the surface of the drum. The drum rotates in a direction 240. Magnetic particles attach 245 to the surface of the drum. These particles are removed from the assembly in the magnetic particle effluent 250 once the particles 215 are no longer in the magnetic field. The magnetic particle effluent may include active ZVI media. The magnetic particle effluent may be at least partially recycled into the fluidized bed reactor 110. Non-magnetic particles are removed from the assembly in the non-magnetic particle effluent 255. The non-magnetic particles may include reaction products of contaminants removed from wastewater in the fluidized bed reactor 110 and/or spent or inactive media. The magnetic drum separation apparatus 200 may thus preferentially or selectively recycle active as opposed to inactive or spent media to the fluidized bed reactor 110. The non-magnetic particle effluent 255 may be further treated and/or disposed of. Examples of magnetic drum separators which may be utilized with aspects and embodiments disclosed herein include those commercially available from Eriez Manufacturing Co.

ZVI media may become inactive when it gets coated with an oxide layer. The inactive media would not be magnetic and would pass through the magnetic drum assembly to downstream aeration, therefore slowly purging the reactor of inactive media. In another embodiment, the system could be operated at increased flow rates with greater rise velocity in the fluidized bed to purposefully purge inactive media while returning the active media via the magnetic separation step. In addition to return of the media to the reactor, in another embodiment it is possible to use magnetic separation for wasting all or a portion of the media when it becomes partially or totally inactive. This may be done as a complete change out of the media in the reactor or partially as a “bleed and feed” activity to maintain reactivity of the media in the reactor, precluding the need for taking the reactor out of operation to perform a complete change out of the media.

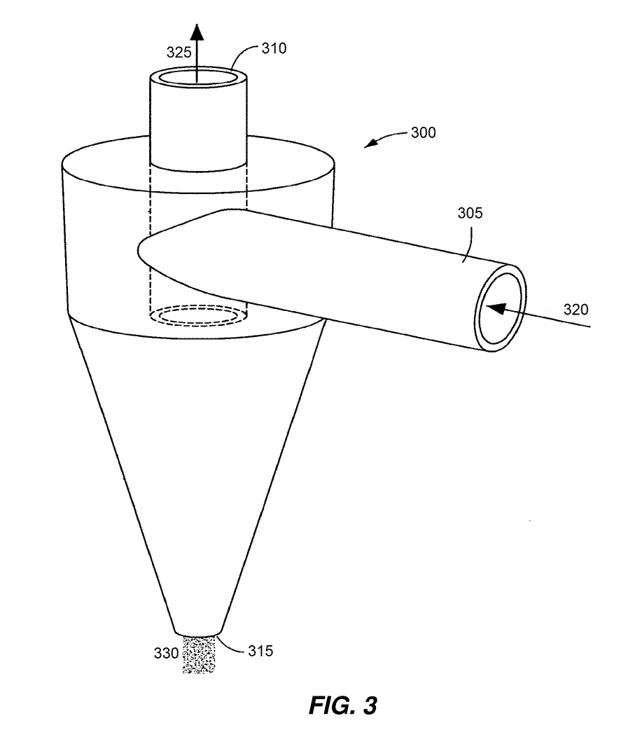

In another embodiment, a gravity based separation device is positioned in fluid communication between the outlet of the fluidized bed reactor 110 and the inlet the aeration basin 155. The gravity based separation device may comprise a hydrocyclone. An embodiment of a hydrocyclone separation device is illustrated in FIG. 3, generally at 300. Fluid 320 from the outlet of the fluidized bed reactor 110 is introduced into the inlet 305 of the hydrocyclone 300. The inlet 305 of the hydrocyclone 300 is positioned on the side of the hydrocyclone 300 so that a spinning motion is imparted to the fluid entering the hydrocyclone 300, generating a vortex within the hydrocyclone. Lighter particles 325 are removed from the device by way of the overflow 310. Heavier particles 330 are removed from the device by way of the underflow 315. Since activated iron particles have a specific gravity of about 5.3 g/cm, they are much heavier than water and thus are removed by the hydrocyclone by way of the underflow 315. Once removed, activated iron particles can be recycled back to the fluidized bed reactor. This will cut down on the attrition of activated iron particles in the process. Differences in density between contaminants or contaminant byproducts removed from the wastewater, spent media, and active media may be capitalized on to selectively return active media as opposed to inactive media and/or contaminants or contaminant byproducts to the fluidized bed reactor.

Different gravity based separation devices or apparatus, for example, a clarifier or other gravity based settling system may be used in addition to or as an alternative to a hydrocyclone for separating particles based on mass and facilitating reducing the loss of activated iron particles or other desired media from a fluidized bed reactor or moving packed bed reactor as disclosed herein.

The present disclosure is not limited to a particular type or configuration of a particular magnetic separation device or a particular gravity based separation device. Various configurations and/or combinations of these devices could be used to accomplish the removal of magnetic particles from an activated iron process effluent and return them to a wastewater treatment reactor.

In some embodiments, a wastewater treatment process is operated utilizing a moving packed bed reactor including mixers and riser tubes (also referred to as a draft tubes) with continuous or intermittent addition of ferrous ions. The riser tube or draft tube provides a pathway to remove media such as ZVI media from the bottom of the packed bed, fluidize the media, and then place the media at the top or inlet side of the packed bed. In some embodiments, a ratio of ZVI media to liquid of about 1:1 or more may be utilized in the moving packed bed reactor. In this way, the process is operated as a packed bed but the media is either continuously or intermittently moved to prevent fusing. In some embodiments, the media may travel from the top of a media bed to the bottom of a media bed and back to the top of a media bed over a course of, for example, less than a week, or between about one day and three days. Effluent quality and its ionic matrix may be some parameters used to determine an amount of time used to turn over the media bed. If contamination concentration increases in the effluent, it may indicate that shorter turnover time is desirable.

In at least some embodiments, a moving packed bed reactor may exhibit substantially zero pressure rise over at least a ten day period. Pressure rise may be dependent on various factors including the ionic matrix of the wastewater, with higher salinities generally being linked to higher pressure rise. In some embodiments, a moving packed bed reactor may exhibit a lower residence time for wastewater undergoing treatment than a fluidized bed reactor, for example, a reduction in residence time by about a factor of six.

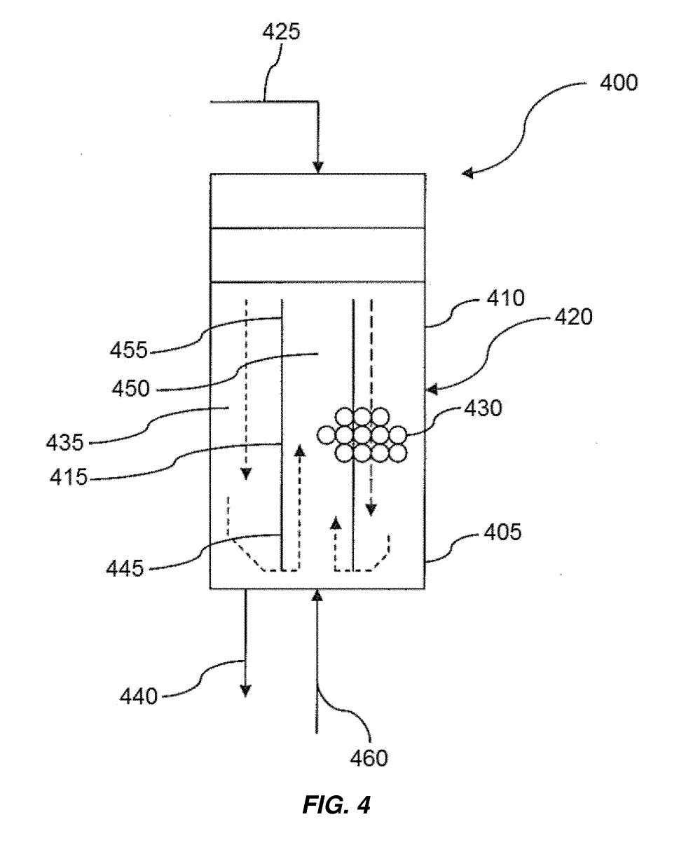

FIG. 4 illustrates an embodiment of a moving packed bed reactor, illustrated generally at 400, with a subsystem comprising a central riser or draft tube to move media from proximate the bottom 405 of the reactor to proximate the top 410. Reactor 400 has a riser 415 located generally in the center of the reactor vessel 420. Influent 425 is treated in the media 430 on the outside 435 of the riser 415 and exits the reactor as treated effluent 440. Media enters the riser tube 415 at the bottom 445 of the riser tube 415 proximate the bottom 405 of the reactor 400. Media 430 within 450 the riser tube is moved in an upward direction. The media 430 inside 450 the riser tube 415 is fluidized causing any fused media 430 to break apart. Media 430 is then spilled over the top 455 of the riser tube 415 and is packed together on the outside 435 portion of the riser tube.

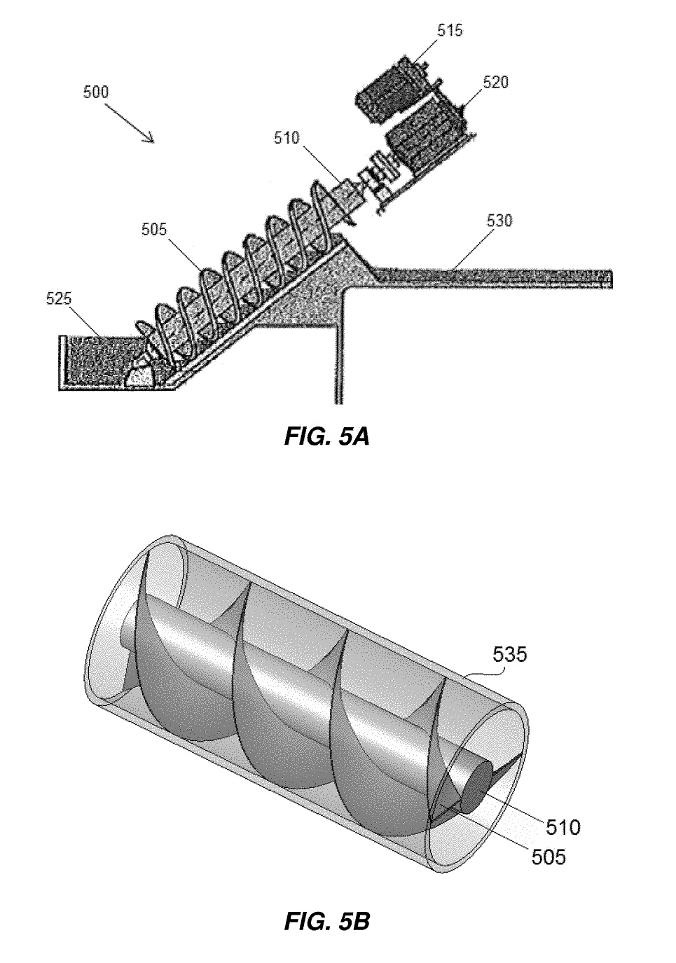

Many different types of subsystems can be used to generate motive force to move the media within the riser tube 415. For example, an auger or screw type device can be used to move the activated iron media from the bottom or effluent side of the reactor to the top or influent side of the reactor. One example of such auger or screw pump is a KWS Archimedean Screw Pump manufactured by Kuhn, GmbH. As illustrated generally in FIG. 5A, an Archimedean screw pump 500 generally includes a main screw element 505 mounted on a shaft 510 which is driven by a motor, for example, an electric motor 515 and associated gearbox 520. Rotation of the shaft 510 and main screw element 505 transports a liquid, for example, containing fluidized media and/or solid media from a lower level 525 to a higher level 530. The main screw element 505 may include unenclosed portions, as illustrated in FIG. 5A, or may be enclosed in a conduit, for example, a tubular conduit 535, as illustrated in FIG. 5B. Enclosing the screw element 505 in a conduit 535 may provide for the screw pump to selectively lift particles above a certain size, which may vary depending on a spacing between the screw element 505 and the inner wall of the conduit 535. An Archimedean screw pump is generally operated at an angle relative to vertical. Thus, when a riser tube of a moving packed bed reactor includes an Archimedean screw pump or similar device, the riser tube may be oriented at an angle relative to vertical within the reactor.

A source of gas, for example, air can be used in a draft tube device to move the activated iron media from the bottom or effluent side of the reactor to the top or influent side of the reactor. In FIG. 4, a source of gas 460 positioned below the riser tube 415 directs gas into the center portion 450 of the riser tube 415. The gas may comprise compressed air. In some processes involving, for example, treatment of contaminated water from oil and gas extraction operations, the gas may be natural gas. This disclosure is not limited by the type of gas used in a gas driven draft tube arrangement.

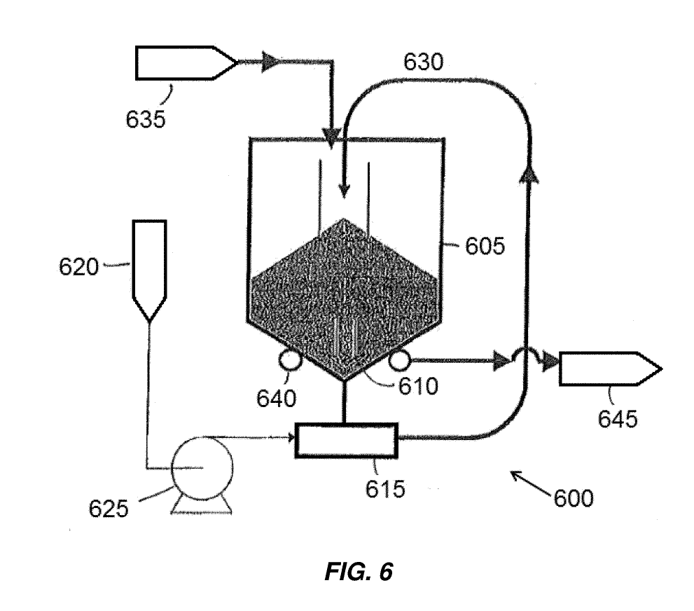

In another embodiment, media is withdrawn from the bottom of the reactor and introduced to the top or feed side of the reactor. One apparatus that may be used to perform this action is an eductor. FIG. 6 illustrates a moving packed bed reactor 600 that comprises a vessel 605 containing media 610, for example, ZVI media. An eductor 615 is operated with a source of motive water 620 and a pump 625 to withdraw media 610 from the bottom of the reactor vessel 605, fluidize the media, and return it to the top of the reactor through line 630. In operation influent 635 including liquid to be treated is directed to the vessel 605 and flows through the media 610, where contaminants are removed, and then to the under drain 640 and out the effluent outlet 645.

In any of the embodiments of a moving packed bed reactor disclosed herein, media, for example, ZVI may be recovered from effluent of the reactor using, for example, a magnetic separation device, for example, as disclosed in FIG. 2, a gravity separation device, for example, a hydrocyclone as illustrated in FIG. 3, or any other separation device known in the art. The discussion regarding magnetic separation devices and gravity separation devices for recycling media and/or for selectively recycling active as compared to inactive media and/or contaminants or contaminant byproducts from effluent of a reactor discussed above with regard to fluidized bed reactors applies equally to embodiments of moving packed bed reactors disclosed herein.

Similarly, in embodiments where media is transported from one portion of a moving packed bed reactor to another, for example, through line 630 illustrated in FIG. 6, the fluidized media may be passed through, for example, a magnetic separation device, for example, as disclosed in FIG. 2, a gravity separation device, for example, a hydrocyclone as illustrated in FIG. 3, or any other separation device known in the art to “clean” the media. Such separation devices may remove spent media or particles other than media, for example, precipitated contaminants or compounds formed therefrom from the fluidized media and to thus selectively supply active media as compared to inactive media and/or contaminants or contaminant byproducts to the moving packed bed reactor through a media circulation line, for example, line 630.

During operation the wastewater treatment process in a reactor such as illustrated in FIG. 6 may be either continuous or intermittent. The result is that the media in the process is moved, fluidized, and directed to the inlet of the apparatus to help avoid fusing of the media.

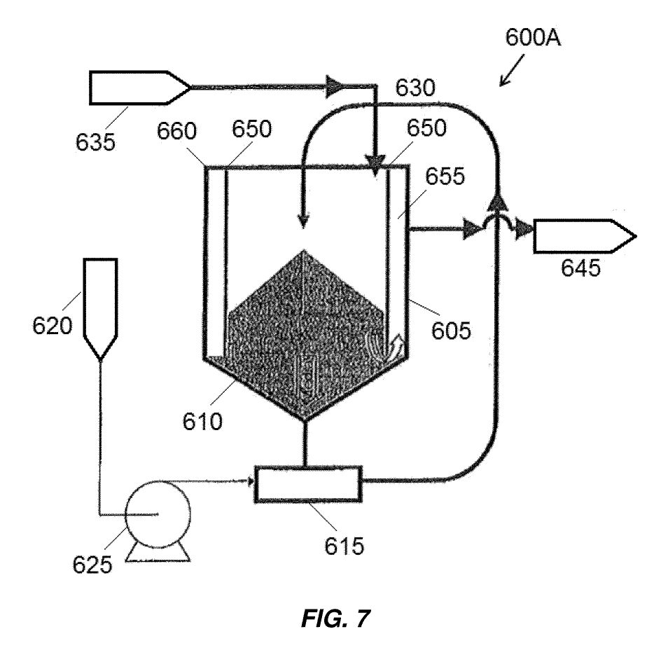

In another embodiment, illustrated generally at 600A in FIG. 7, a moving packed bed reactor may be provided with a baffle or baffles 650. The baffle(s) 650 may, in some embodiments, be formed substantially concentrically and spaced inside an outer wall 660 of the reactor vessel 605. Effluent may be drawn to the effluent outlet 645 from a space 655 between the baffle(s) 650 and the outer wall 660 of the reactor vessel 605. In the reactor 600A, the fluid to be treated may be forced to flow through a known depth of media material due to the placement of the baffle(s) 650. The baffle(s) 650 may also provide a quiescent zone in space 655, which may provide for clarification of the effluent prior to removal through the effluent outlet 645.

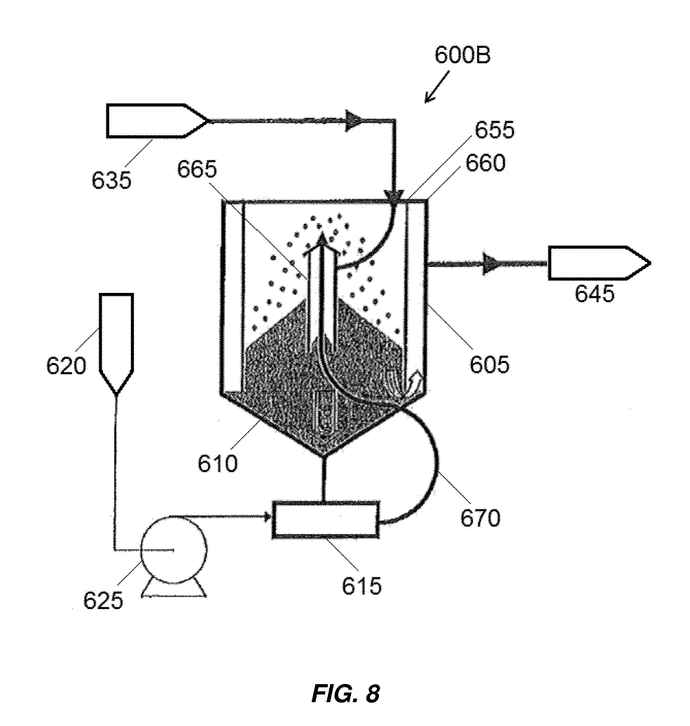

In another embodiment, illustrated generally at 600B in FIG. 8, a moving packed bed reactor may include a mechanism for introducing feed water to be treated generally into the center of the media bed 610. As illustrated in FIG. 8, reactor 600B includes a centrally located distributor tube 665, which, in some embodiments, may be generally coaxial with the outer wall 660 of the vessel 605. Feed water to be treated from a source of influent 635 may be introduced into an internal volume of the distributor tube 665. The distributor tube 665 may be open only at its lower end, thus forcing feed water to be treated through the open lower end and into the center of the media bed 610 or in other embodiments, into a lower portion of a media bed 610. In some embodiments, the media recirculation line 670 passes through the distributor tube 665, delivering a plume of recycled media to the upper surface of the media bed 610. In some embodiments, the media recirculation line 670 is substantially coaxial with the distributor tube 665.

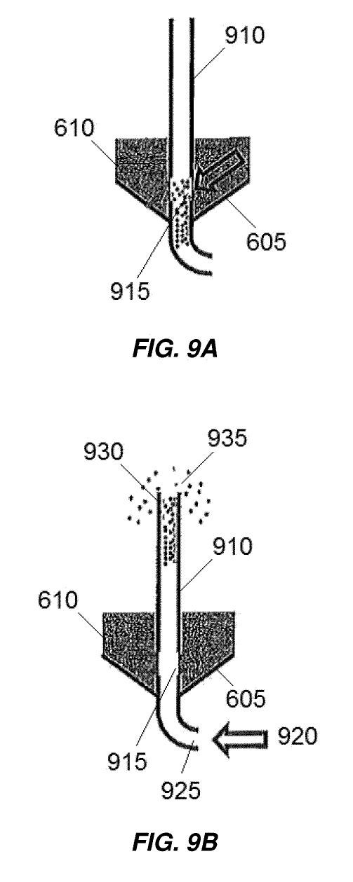

An eductor has been illustrated in FIGS. 6, 7, and 8 as providing for the recirculation of media in the media bed 610. In other embodiments, in addition to or as an alternative to an eductor, a system of tubes may be utilize to facilitate recirculation of media in a media bed of a moving packed bed reactor. FIGS. 9A and 9B illustrate one example of how one embodiment of such an arrangement of tubes may function. FIGS. 9A and 9B illustrate only a lower portion of a moving packed bed reactor vessel. Illustrated in FIGS. 9A and 9B is a lower portion of the reactor vessel 605 containing a bed of media 610. A media recirculation tube 910 is illustrated entering the reactor vessel 605 through a lowermost portion thereof, although in other embodiments, one or more media recirculation tubes 910 may be present, or media recirculation tube 910 may enter the reactor vessel 605 at a different point or from a different direction, for example, from a side of the reactor vessel 605. The media recirculation tube 910 includes one or more apertures 915 through which media enters the media recirculation tube 910 during operation of the reactor vessel, for example, under the force of gravity.

Periodically, on a regular or irregular basis, a pulse 920 of a fluid, for example, compressed air or liquid applied to a lower end 925 of the media recirculation tube 910 causes media which has entered the media recirculation tube 910 to be ejected from an upper end 930 of the tube, forming a media plume which settles on the upper surface of the media bed. The mass of the media in the media bed 610 causes the media in the media recirculation tube 910 to be ejected upward instead of back through the aperture(s) 915 in the media recirculation tube 910. In some embodiments, the pulse 920 of fluid may be provided from a diaphragm pump (not shown) although any method known in the art of providing a fluid pulse may be utilized. The pulse 920 of fluid may be a pulse of fluid withdrawn from an internal portion of the reactor vessel 605.

In some embodiments, a moving packed bed reactor may include multiple stages. The stages may be stacked vertically to produce a device that incorporates the functionality of several single stage units into one device, removing the need to have multiple ancillaries while providing for solids recycle and trapping of high value fines, for example, active media, within the unit. The unit may, for example, be capped with a separation device, for example, a moving bed sand filter, hydrocyclone, or magnetic separator to allow for the recovery of fines from the final stage. Forming the unit from a vertically arranged stack of subunits provides for the device to be factory assembled and field erected, reducing site work and overall cost.

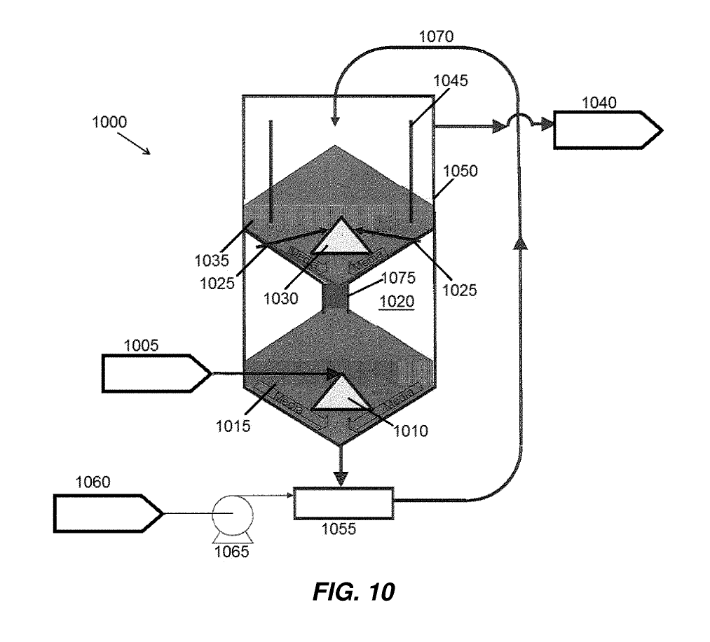

An embodiment of a stacked moving packed bed reactor is illustrated generally at 1000 in FIG. 10. In reactor 1000, water to be treated (feed) from a source of influent 1005 is introduced to a generally central portion 1010 of a lower media bed 1015 in a lower section of the reactor 1000. The feed flows through the lower media bed 1015, where contaminants are removed from the feed, and enters a liquid space 1020 above the lower media bed 1015. The liquid space 1020 may function as a clarification zone for the partially treated feed. From the liquid space 1020, the partially treated feed passes through one or more conduits, for example, pipes 1025 into a generally central portion 1030 of an upper media bed 1035 in an upper section of the reactor 1000. The partially treated feed passes through the upper media bed 1035, where additional contaminants are removed to form an effluent. Fines, for example, precipitated contaminants and/or spent media generated in the lower media bed 1015 may be removed from the partially treated feed in the upper media bed 1035 by bed filtration. Effluent may be removed and supplied to an effluent outlet 1040 from above the upper media bed 1035, for example, from a space between one or more baffles 1045 and an outer wall 1050 of the reactor vessel. The baffles 1045 may provide a quiescent zone in the space between the one or more baffles 1045 and the outer wall 1050 of the reactor vessel which may facilitate additional separation of precipitated solids, for example, precipitated contaminants from the effluent by clarification or gravity separation.

Media circulation in reactor 1000 may be effected by utilizing an eductor 1055 supplied with water from a source of motive water 1060 through a motive water pump 1065. The eductor 1055 removes media from the lower portion of the lower media bed 1015 and distributes the media via media circulation line 1070 on the top of the upper media bed 1035. Media may travel from the upper media bed 1035 to the lower media bed 1015 through a conduit 1075, for example, under the force of gravity.

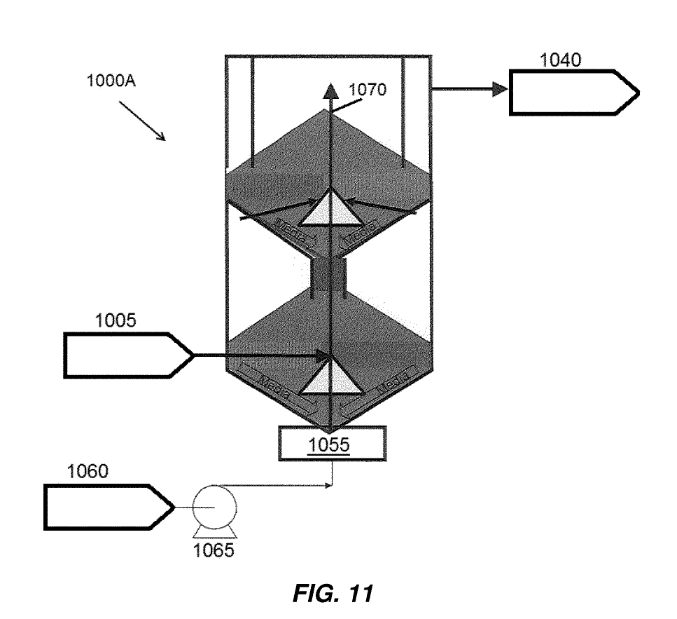

In a modification to the moving packed bed reactor 1000, indicated generally at 1000A in FIG. 11, the media circulation line 1070 may be disposed internal, for example, along a central vertical axis of the reactor vessel.

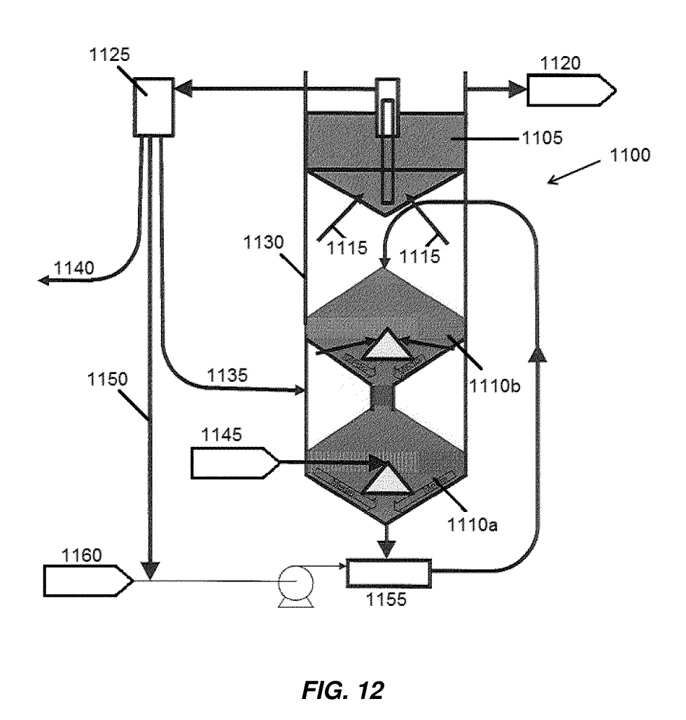

In various embodiments, a stacked moving packed bed reactor may include additional features which may facilitate the recovery of media, for example, ZVI media, that might otherwise escape in the effluent stream of the reactor and/or the removal of contaminants from the recovered media. For example, moving packed bed reactor 1100, illustrated in FIG. 12 may include one or more features for separating particles from effluent before releasing the effluent from the reactor. Moving packed bed reactor 1100 may include, for example, a moving bed sand filter 1105. A partially treated effluent which has passed through the two media beds 1110a, 1110b, enters the moving bed sand filter 1105 thorough inlet lines 1115. Particles in the partially treated effluent are trapped in the sand in the moving bed sand filter 1105 and a first “clean” effluent exits from an upper portion of the moving bed sand filter 1105 to effluent outlet 1120.

A second “dirty” effluent including particles from the partially treated effluent that were trapped in the moving bed sand filter 1105 is directed to a media separator device 1125. The media separator device 1125 may include, for example, a hydrocyclone and/or other gravity based separator, a magnetic separator, or any other separator known in the art capable of separating media and/or other solids from the second dirty effluent from the moving bed sand filter 1105.

The media separator device 1125 may separate the second dirty effluent from the moving bed sand filter 1105 into a media stream 1135 rich in media, for example, ZVI media as compared to the second dirty effluent from the moving bed sand filter 1105, a waste stream 1140 rich in waste materials, for example, contaminants which were precipitated or otherwise separated from influent 1145 which was treated in the reactor as compared to the second dirty effluent from the moving bed sand filter 1105, and/or a liquid stream 1150 lean in both waste materials and media. Active media may be selectively separated into media stream 1135 while inactive media may be selectively separated into waste stream 1140 so that media stream 1135 has a higher proportion of active to inactive media than the fluid stream entering the media separator device 1125. The media stream 1135 separated in the media separator device 1125 may be recycled to the reactor at a point in the reactor vessel 1130 above the lower media bed 1110a but below the upper media bed 1110b as illustrated in FIG. 12, above the upper media bed 1110b, into the eductor 1155, or any other portion of the reactor as desired. The waste stream 1140 may be sent for further processing and/or disposed of. The liquid stream 1150 may be sent on for further treatment and/or disposed of or recycled, for example, into the stream of motive water 1160 as illustrated and/or into the source of influent 1145 and/or into any other part of the reactor system as desired.

Although illustrated as used with a stacked moving packed bed reactor in FIG. 12, separation devices such as the moving bed sand filter 1105 and/or media separator device 1125 may additionally or alternatively be utilized with any of the other reactors disclosed herein.

The present disclosure is not limited to the type of apparatus utilized to move media comprising an activated iron media in a packed bed reactor. Various configurations of these subsystems comprising devices could be used to accomplish the removal of media from an activated iron process and return the media such as ZVI media to the reactor.

Having thus described several aspects of at least one embodiment, it is to be appreciated various alterations, modifications, and improvements will readily occur to those skilled in the art. Such alterations, modifications, and improvements are intended to be part of this disclosure, and are intended to be within the spirit and scope of the disclosure. One or more features of any one embodiment disclosed herein may be combined with or substituted for one or more features of any other embodiment disclosed. Accordingly, the foregoing description and drawings are by way of example only.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

What is claimed is:

1. A wastewater treatment system, comprising:
a wastewater inlet;
a vessel including a moving packed media bed, the vessel configured to receive wastewater to be treated from the wastewater inlet and to contact the wastewater to be treated with a catalyzing media in the moving packed media bed to produce treated water;
an effluent outlet in fluid communication with the vessel and configured to receive the treated water from the vessel; and
a media recirculation system configured to transport catalyzing media from a first portion of the moving packed media bed to a second portion of the moving packed media bed.

2. The wastewater treatment system of claim 1, wherein the media recirculation system includes:
a riser tube; and
a motive force generator configured to move catalyzing media up through the riser tube.

3. The wastewater treatment system of claim 2, wherein the motive force generator includes an auger.

4. The wastewater treatment system of claim 2, wherein the motive force generator includes a gas inlet disposed beneath the riser tube.

5. The wastewater treatment system of claim 1, wherein the media recirculation system includes an eductor in fluid communication with a source of motive water.

6. The wastewater treatment system of claim 1, wherein the media recirculation system includes:
a conduit passing through the moving packed media bed, the conduit including an aperture in communication with the catalyzing media and an upper end positioned over the top of the moving packed media bed; and
a fluid pulse generator configured to apply a fluid pulse to the conduit and eject catalyzing media from within the conduit into a media plume above the top of the moving packed media bed.

7. The wastewater treatment system of claim 1, further comprising a media recovery system in fluid communication with the effluent outlet and configured to remove catalyzing media from the effluent and return the catalyzing media to the vessel.

8. A wastewater treatment system, comprising:
a wastewater inlet;
a vessel including a moving packed media bed, the vessel configured to receive wastewater to be treated from the wastewater inlet and to contact the wastewater to be treated with a catalyzing media in the moving packed media bed to produce treated water;
an effluent outlet in fluid communication with the vessel and configured to receive the treated wastewater from the vessel;
a media recirculation system configured to transport catalyzing media from a first portion of the moving packed media bed to a second portion of the moving packed media bed; and
a media recovery system in fluid communication with the effluent outlet and configured to remove catalyzing media from the effluent and return the removed catalyzing media to the vessel.

9. A method of treating wastewater, the method comprising:
introducing the wastewater into a reactor including a catalyzing media;
contacting the wastewater with the catalyzing media in the reactor to form an effluent;
moving a portion of the catalyzing media from a first position in the reactor to a second position in the reactor;
removing the effluent from the reactor;
removing catalyzing media from the effluent removed from the reactor; and
recycling the removed catalyzing media to the reactor.

10. The method of claim 9, wherein moving the portion of the catalyzing media comprises forming a moving packed bed from the catalyzing media in the reactor.

11. The method of claim 10, wherein moving the portion of the catalyzing media from the first position in the reactor to the second position in the reactor includes moving the portion of the catalyzing media from a lower portion of the moving packed bed to an upper portion of the moving packed bed.

12. A wastewater treatment system, comprising:
a wastewater inlet in fluid communication with a source of wastewater including a soluble heavy metal contaminant;
a vessel configured to receive wastewater to be treated from the wastewater inlet and contact the wastewater to be treated with a catalyzing media in the vessel, the catalyzing media configured to one of precipitate and adsorb at least a portion of the soluble heavy metal contaminant and produce treated water;
an effluent outlet in fluid communication with the vessel and configured to receive the treated water from the vessel; and
a media recovery system in fluid communication with the effluent outlet and configured to selectively remove active catalyzing media as compared to spent catalyzing media from the treated water and return the active catalyzing media to the vessel.

13. The wastewater treatment system of claim 12, wherein the media recovery system includes a gravity-based separator.

14. The wastewater treatment system of claim 12, wherein the media recovery system includes a magnetic separator.

15. The wastewater treatment system of claim 12, wherein the vessel includes a fluidized bed reactor.

16. The wastewater treatment system of claim 12, wherein the vessel includes:
a packed bed reactor including a moving packed bed of the catalyzing media; and
a subsystem configured to generate the moving packed bed of the catalyzing media by moving catalyzing media from a bottom of the packed bed to a top of the packed bed.

17. The wastewater treatment system of claim 16, wherein the subsystem includes:
a riser tube; and
a motive force generator configured to move catalyzing media up through the riser tube.

18. The wastewater treatment system of claim 17, wherein the motive force generator includes an auger.

19. The wastewater treatment system of claim 17, wherein the motive force generator includes a gas inlet disposed beneath the riser tube.

20. The wastewater treatment system of claim 16, wherein the subsystem includes an eductor in fluid communication with a source of motive water.

21. The wastewater treatment system of claim 16, wherein the subsystem includes a sand filter.

22. The wastewater treatment system of claim 16, wherein the subsystem includes:
a conduit passing through the packed bed, the conduit including an aperture in communication with the catalyzing media and an upper end positioned over the top of the packed bed; and
a fluid pulse generator configured to apply a fluid pulse to the conduit and eject catalyzing media from within the conduit into a media plume above the top of the packed bed.

23. The wastewater treatment system of claim 16, wherein the vessel includes a plurality of stacked packed media beds.

24. A method of treating wastewater including a soluble contaminant, the method comprising:
introducing the wastewater into a vessel including a catalyzing media, the catalyzing media configured to one of precipitate and adsorb at least a portion of the soluble contaminant and produce treated water;
removing the treated water from an effluent outlet in fluid communication with the vessel;
selectively removing active catalyzing media as compared to spent catalyzing media from the treated water; and
returning the active catalyzing media to the vessel.

25. The method of claim 24, wherein the soluble contaminant is a heavy metal.

26. The method of claim 25, wherein the soluble contaminant includes one of selenium, mercury, and thallium.
